(19) United States
(12) Patent Application Publication
(10) Pub. No.: US 2011/0040903 A1
(43) Pub. Date: Feb. 17, 2011

(54) METHODS AND APPARATUS FOR AUTOMATED PERFORMANCE LIMITING OF AN I/O CONTROL DEVICE

(75) Inventors: Randolph W. Sterns, Arvada, CO (US); Randy K. Hall, Boulder, CO (US)

Correspondence Address: Duft Bornsen & Fishman LLP, 1526 Spruce Street, Suite 302, Boulder County, CO, 80302, US

(73) Assignee: LSI CORPORATION, Milpitas, CA (US)

(21) Appl. No.: 12/542,250

(22) Filed: Aug. 17, 2009

(51) Int. Cl. G06F 3/00

(52) U.S. Cl. 710/39

(57) ABSTRACT

Methods and apparatus for configurably limiting performance of an I/O controller device in processing of I/O requests. A performance monitor and control module in the I/O controller device monitors performance of the I/O request processing module and limits its processing to assure that maximum performance threshold values are not exceeded. In one embodiment, the performance monitoring may average performance over one or more periods of time and may provide a moving average window to determine the performance of the I/O controller device. The measured performance may determine a variety of performance measures each of which may be compared against one or more corresponding maximum performance threshold values. Requests that cannot be processed during a present period of time are delayed until a subsequent period of time to thereby limit performance of the I/O controller device.

### BACKGROUND

1. Field of the Invention

The invention relates generally to input/output (I/O) controller devices and more specifically relates to techniques and apparatus for providing a variety of performance levels in a single I/O controller circuit design.

2. Discussion of Related Art

Input/Output (I/O controller devices typically control an associated I/O device and enable communications between the I/O device and host systems or other sources of generating I/O requests to exchange data. Manufacturers of such I/O controller devices (such as storage controller devices) often produce a family of related controller products where each member of the family offers a different level of performance—lower cost, lower performance controllers and higher cost, higher performance models.

At present, manufacturers design such a family of product by using different hardware/circuit designs to upgrade or downgrade performance of each model of the controller device. For example, a higher performance model may use a faster main processor and memory or may use more “lanes” of a Peripheral Component Interconnect Express (PCI Express) internal connection to enhance performance of the controller in processing I/O requests. By contrast, a lower performance model may use slower processor and memory components or may not include custom assist circuits designed into the higher performance models of the controller.

Such hardware re-design techniques raise a number of problems. First, each controller model with its corresponding desired performance level may require design, debug, and maintenance of a unique design. The manufacturer is thus burdened with added design, manufacture, and support costs due to the proliferation of controller models. Further, a hardware design that attempts to lower performance by restricting use of a particular circuit or by removing an assist circuit from the lower cost design may not achieve the desired reduced performance for all mixes of I/O requests. Some types of I/O requests may utilize different processing logic within the controller that avoid the restricted or removed circuitry such that the controller performance may vary depending on the mix of types of requests processed.

Thus it is an ongoing challenge to provide a family of controller models having different performance characteristics.

### SUMMARY

The present invention solves the above and other problems, thereby advancing the state of the useful arts, by providing methods and apparatus for configurably limiting performance of an I/O controller device. A performance monitor and control module operates in cooperation with the I/O request processing module within the I/O controller to process I/O requests while assuring that the configured maximum performance threshold values are not exceeded.

In one aspect hereof, a method is provided operable in an I/O controller device for limiting performance of the I/O controller device. The method includes determining, within the I/O controller device, a maximum performance threshold value for the I/O controller device and determining, within the I/O controller device, performance of the I/O controller device during processing of I/O requests by the I/O controller device. The method then delays processing of an I/O request within the I/O controller device to maintain performance of the I/O controller device below the maximum performance threshold value.

Another aspect hereof provides an I/O controller device adapted to provide a configurable level of performance. The controller device includes an I/O request processing module adapted to receive I/O requests from one or more host systems and adapted to exchange information with one or more I/O devices to process the received I/O requests. The controller also includes a memory for storing one or more maximum performance threshold values and a performance monitor and control module coupled with the I/O request processing module and coupled with the memory. The performance monitor and control module operable to monitor performance of the I/O request processing module and operable to control operation of the I/O request processing module responsive to the monitoring to assure that performance of the I/O request processing module does not exceed any of the one or more maximum performance threshold values.

### BRIEF DESCRIPTION OF THE DRAWINGS

FIG. 1 is a block diagram of an exemplary system including an I/O controller device enhanced in accordance with features and aspects hereof to configurably limit performance of the controller.

FIG. 2 is a flowchart describing an exemplary method in accordance with features and aspects hereof to monitor and control processing of I/O requests in an I/O controller device to avoid exceeding maximum performance threshold values.

FIG. 3 is a flowchart describing an exemplary method in accordance with features and aspects hereof to monitor and control processing of I/O requests in an I/O controller device to avoid exceeding maximum performance threshold values.

FIG. 4 is a flowchart describing exemplary additional details of processing of I/O requests in an I/O controller device so as to limit performance of the controller.

FIG. 5 is a block diagram of a computing device in an exemplary I/O controller device that executes programmed instructions embodying methods to configurably limit performance of the I/O controller device in processing of I/O requests.

### DETAILED DESCRIPTION OF THE DRAWINGS

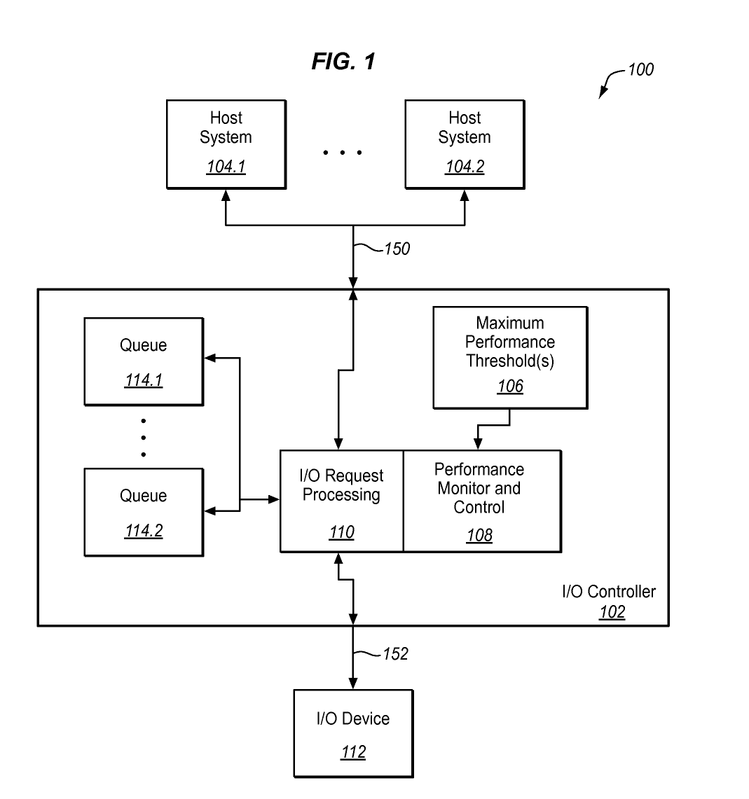

FIG. 1 is a block diagram of an exemplary system 100 including an I/O controller device 102 enhanced in accordance with features and aspects hereof to controllably limit performance of the controller device. I/O controller device 102 may be coupled via path 150 to one or more host systems 104.1 through 104.2. I/O controller 102 is also coupled to one or more I/O devices 112 to be controlled via path 152. I/O controller device 102 receives I/O requests from systems 104.1 through 104.2 and processes such requests to perform requested read, write, and other operations on I/O devices 112 via path 152. Path 150 coupling I/O controller device 102 to host systems 104.1 through 104.2 may be any suitable communication media and protocol including, for example, parallel SCSI, Serial Attached SCSI (SAS), parallel Advanced Technology Attachment (ATA), Serial Advanced Technology Attachment (SATA), or any of numerous other well known, commercially available communication media and protocols. Communication path 152 coupling I/O controller device 102 to I/O devices 112 may likewise be any suitable communication medium and protocol including, for example, SCSI, SAS, ATA, SATA, or any other suitable, well known, commercially available or custom media and protocols. In one exemplary embodiment, I/O controller device 102 may be a storage controller such as a RAID storage controller coupling one or more host systems 104.1 through 104.2 to a plurality of disk storage devices 112 for purposes of performing RAID storage management. In such an environment, I/O controller device 102 processes storage I/O requests on behalf of the host systems for reading and writing information on storage devices 112.

In accordance with features and aspects hereof, I/O controller device 102 includes an I/O request processing module 110 operable under control of performance monitor and control module 108. As I/O requests are received and processed by I/O request processing module 110, performance monitor and control module 108 monitors the performance of the processing of I/O requests by processing module 110. Performance monitor and control module 108 retrieves information from a suitable memory storing maximum performance threshold values 106. The threshold values represent the maximum performance configured for operation of I/O controller device 102. The manufacturer of I/O controller device 102 may provide different maximum performance threshold values 106 to allow configuration of a variety of performance levels in marketing a family of related I/O controller devices 102. By simply altering the maximum performance threshold values 106 stored in a suitable memory of I/O controller device 102, a manufacturer may provide a plurality of models of I/O controller device 102 each having a different maximum performance threshold characteristic but operating on the same physical controller design. Such performance threshold value information may be stored in a secured, read-only memory device on the controller programmed/configured only at time of manufacture. In other embodiments, a manufacturer may provide a modifiable configuration for the maximum performance threshold values 106. Such re-programmable values may be stored in a re-writable memory device of the controller and may be secured by a key so that an authorized end user may re-program the controller to permit higher performance levels. Methods and structures for allowing reprogramming of the maximum performance threshold values 106 in a memory of the I/O controller device 102 will be readily apparent to those of ordinary skill in the art.

Performance monitor and control module 106 may monitor a variety of performance criteria/measurements to determine the present performance of the I/O controller device 102. The performance criteria may include, for example, the total number of I/O requests processed, the total volume of data exchanged between the I/O controller device 102 and the host systems, the number of I/O requests satisfied by use of a cache memory (not shown) associated with controller device, the number of I/O requests satisfied without the use of the cache memory, etc. One or more such performance criteria are measured by performance monitor and control module 108 and compared with corresponding one or more maximum performance threshold values 106.

In one exemplary embodiment, such performance criteria are measured over a determined period of time of operation of the I/O controller device. Thus an average performance measurement over a period of time may be compared with the specified one or more maximum performance threshold values 106. Still further, in an exemplary embodiment, the period of time may be altered and a number of such periods of time may be specified to produce an average performance measurement. Thus the performance measurements and threshold values may specify comparisons to be made through a “moving window” of time of operation of the controller device 102. In such a moving window measurement, a specified previous number of time periods may be measured and averaged to determine the average performance over the present moving window period of time.

When a new I/O request is received from a host system 104.1 through 104.2, performance monitor and control module 108 determines whether the I/O request may be processed within the present period of time without exceeding any of the maximum performance threshold values. If not, the request may be delayed until a subsequent period of time. In one exemplary embodiment, I/O controller device 102 may include a memory storing one or more queues 114.1 through 114.2. Each queue may be associated with a corresponding host system 104.1 through 104.2. In such an exemplary embodiment, a newly received I/O request is first entered into the queue corresponding to the host system that generated the newly received request. Performance monitor and control module 108 in conjunction with I/O request processing module 110 then looks for a next I/O request on any of the queues that may be performed within the present period of time by comparing the performance measurements (e.g., average performance during the present period of time) against corresponding maximum performance threshold values 106. When a next I/O request is located that may be performed within the present period of time, the request may be unqueued by I/O request processing module 110 and processed to completion by exchanging related data with I/O device 112. Requests that cannot be processed during the present of time remain queued until a next period of time when the performance monitor and control module 108 in conjunction with I/O processing module 110 attempts again to locate an I/O request to be processed.

Those of ordinary skill in the art will readily recognize that performance monitor and control module 108 and I/O request processing module 110 may be implemented as suitably programmed instructions executed by a general or special purpose processor (not shown) within I/O controller device 102. In other embodiments, the functions of I/O request processing module 110 and performance monitor and control module 108 may be implemented as suitably designed custom circuits and/or combinations of custom circuits and suitably programmed instructions executed by a general or special purpose processor. Still further those of ordinary skill in the art will readily recognize numerous additional and equivalent functional modules within a fully operable I/O controller device 102. Such additional and equivalent modules are omitted for simplicity and brevity of this discussion. Still further, those of ordinary skill in the art will readily recognize numerous types of memory components that may be utilized for storing the maximum performance threshold values 106 and queues 114. 1 through 114.2. Threshold values may be stored in a read-only memory as statically configured by a manufacturer or may be stored in a re-programmable memory device to allow authorized users to upgrade performance of a previously installed I/O controller device. Queues 114.1 through 114.2 may be stored in any suitable RAM device.

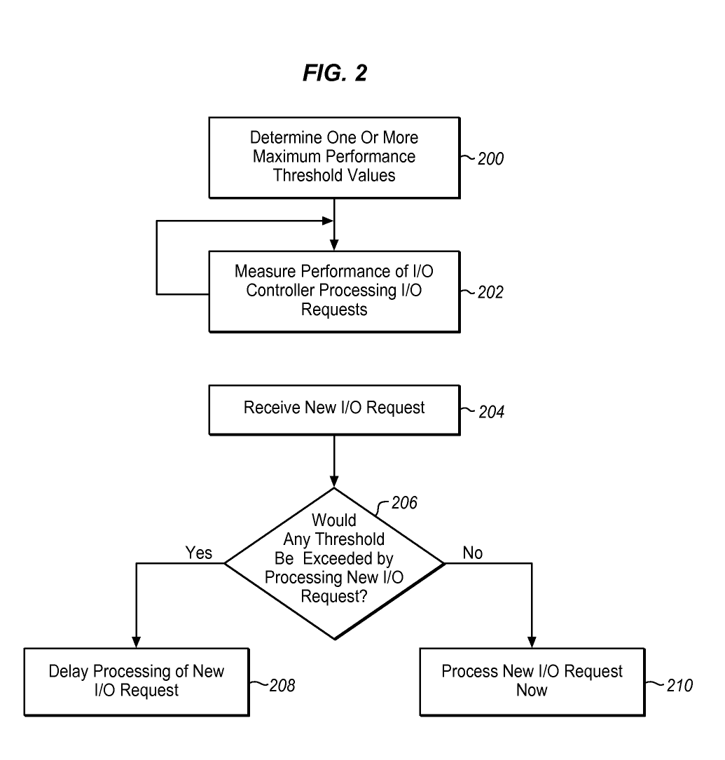

FIG. 2 is a flowchart describing an exemplary method operable in an I/O controller device such as the controller depicted and described above with respect to FIG. 1. The method of FIG. 2 processes I/O requests in a manner to assure that none of the one or more maximum performance threshold values are exceeded in the processing of received I/O requests. Step 200 determines one or more maximum performance threshold values to be imposed on the operation of the I/O controller device. As noted above, such maximum performance threshold values may be stored in a memory associated with the I/O controller device. Step 202 then continuously (e.g., periodically) measures/monitors the performance of the I/O controller device while processing received I/O requests. As noted above, step 202 may measure performance with respect to any of a number of criteria associated with operation of the I/O controller device. Still further, the performance may be measured over a period of time such that an average performance is determined for each period of time. Still further, the period of time may be a moving average window such that the average performance over a previous consecutive number of periods of time may be determined. In some embodiments the period of time and the number of such periods to average in a moving average window may be configured.

Substantially concurrently with the ongoing measurement of performance of the I/O controller device, step 204 may receive a new I/O request from an attached host computing system. Step 206 then determines whether the newly received request may be processed by the I/O controller device without exceeding any of the determined maximum performance threshold value. If processing of the newly received I/O request would cause the measured performance (e.g., average performance) to exceed any of the maximum performance threshold values, step 208 delays processing of the newly received I/O request until a subsequent time during which the I/O request may be processed without exceeding any of the maximum performance threshold values. If the newly received I/O request may be processed during the present period of time without exceeding any of the maximum performance threshold values, step 210 processes the newly received request and adjusts performance measurements to account for the processing of the I/O request. Steps 204 through 210 are repeated for each newly received I/O request delaying any I/O requests that would cause the performance of the I/O controller device to exceed any of the maximum performance threshold values and processing a received request that may be performed without exceeding any of the maximum performance threshold values.

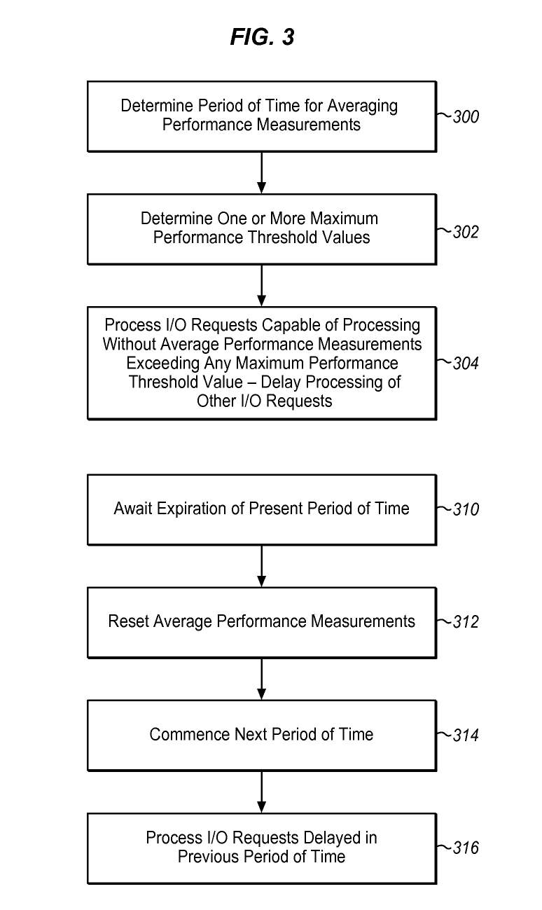

FIG. 3 is a flowchart describes another exemplary method of the processing of an I/O controller device so as to assure that the maximum performance threshold values are not exceeded. Step 300 determines the period of time for averaging performance measurements of the I/O controller device. As above, the period of time used for averaging measurements of performance may be modified to provide desired performance levels in particular applications. For example, where the I/O requests processed are generally smaller requests a shorter period of time for average measurements may be more appropriate whereas for I/O requests that are generally larger requests a longer period of time may be appropriate for averaging performance of the I/O controller device. Step 300 may also determine the number of consecutive preceding periods of time to be used in a moving average window measurement. Step 302 determines one or more maximum performance threshold values against which the average performance of the I/O controller device is compared. As noted above, the maximum performance threshold values and the corresponding measurements may include: the number of I/O requests processed, the total volume of data exchanged with the I/O controller in processing I/O requests, the number of I/O requests processed utilizing cache memory of the I/O controller device, the number of I/O requests processed utilizing without utilizing cache memory of the I/O controller device, etc. Step 304 represents ongoing processing of I/O requests capable of being processed without the average performance measurements exceeding any of the maximum performance threshold values. I/O requests that cannot be processed during the current period of time without exceeding maximum performance threshold values are delayed to await processing during a subsequent period of time. Substantially concurrently with the processing of step 304, steps 310 through 316 await expiration of a present period of time for measuring performance and commence a next period of time. Step 310 awaits expiration of the present period of time during which I/O requests are being processed and/or delayed as indicated above in step 304. Upon detection of expiration of the present period of time, step 312 resets the average performance measurements and step 314 commences the next period of time for new average performance measurements. Step 316 initiates processing of I/O requests delayed in the previous period of time during the newly commenced next period of time. Such processing is similar to that of step 304 above to determine which delayed I/O requests may be processed during the newly commenced next period of time and which may be further delayed until another subsequent period of time.

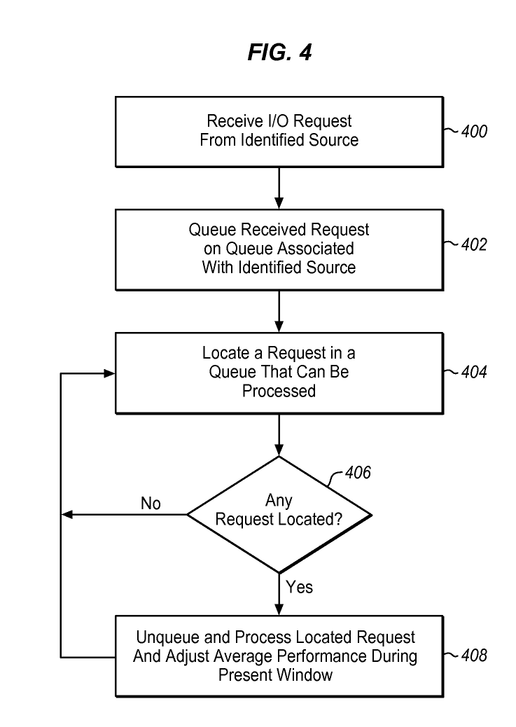

FIG. 4 is a flowchart providing exemplary additional details for the processing of I/O requests in a manner to avoid exceeding any of the one or more maximum performance threshold values. As noted above in FIG. 1, the I/O controller device in one exemplary embodiment may include a plurality of queues stored in a suitable memory, each queue associated with a corresponding host system coupled to the I/O controller device. Step 400 receives a new I/O request from an identified source (e.g., an identified host system). Step 402 queues the received I/O request on one of the plurality of queues associated with the identified source of the received I/O request. Steps 404 through 408 are then iteratively operable to continually attempt locate a request in one of the plurality of queues that may be processed during the present period of time so that the average performance of the I/O controller device does not exceed any of the maximum performance threshold values. In particular, step 404 attempts to locate a request in one of the plurality of queues that can be processed during the present period of time. In general, only the oldest (topmost) queued I/O request in each queue will be inspected to determine whether it may be performed within the present period of time. Those of ordinary skill in the art will recognize that enhancements to the method may include locating queued requests in a different sequence than the order in which they are queued so long as data integrity is assured in the data to be transferred. For example, in some I/O controller device applications, the order of data exchanged between a host system and the I/O device through the I/O controller device may be less critical because each transmission may include a sequence ID or other tag information to assure that the exchanged data will be processed in a correct sequence. Step 406 then determines whether any queued I/O request has been located by the search of step 404. If not, processing continues looping back to step 404 until such time as a request is located that may be processed during the present period of time. If such a request is located, step 408 unqueues the located I/O request and processes the I/O request as discussed above. The processing of such a request also adjusts the average performance measurements for the present period of time to reflect the processing of the located and unqueued I/O request. Processing then continues looping back to step 404 to attempt to locate another queued request that can be processed during the present period of time.

Those of ordinary skill in the art will recognize additional and equivalent method steps relative to the methods discussed in FIGS. 2 through 4. Such additional and equivalent method steps are omitted herein for simplicity and brevity of this discussion.

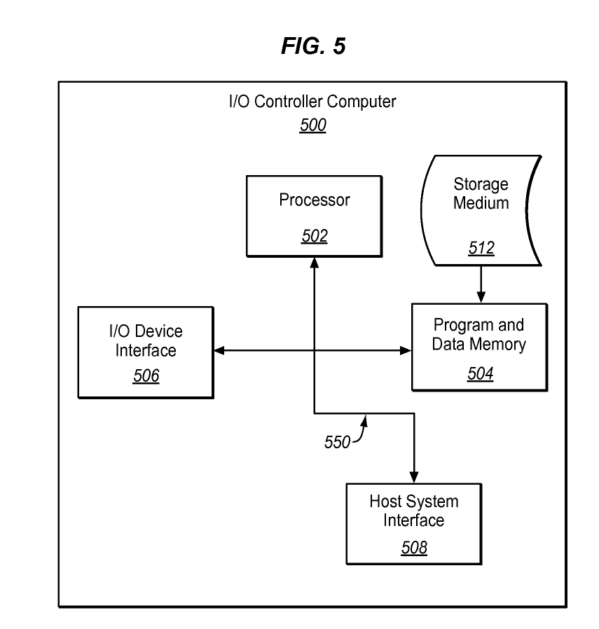

Embodiments of the invention can take the form of an entirely hardware (i.e., circuits) embodiment, an entirely software embodiment or an embodiment containing both hardware and software elements. In one embodiment, the invention is implemented in software, which includes but is not limited to firmware, resident software, microcode, etc. FIG. 5 is a block diagram depicting an I/O controller device computer 500 adapted to provide features and aspects hereof by executing programmed instructions and accessing data stored on a computer readable storage medium 512.

Furthermore, embodiments of the invention can take the form of a computer program product accessible from a computer-usable or computer-readable medium 512 providing program code for use by or in connection with a computer or any instruction execution system. For the purposes of this description, a computer-usable or computer readable medium can be any apparatus that can contain, store, communicate, propagate, or transport the program for use by or in connection with the computer, instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

An I/O controller device computer 500 suitable for storing and/or executing program code will include at least one processor 502 coupled directly or indirectly to memory elements 504 through a system bus 550. The memory elements 504 can include local memory employed during actual execution of the program code, bulk storage, and cache memories which provide temporary storage of at least some program code in order to reduce the number of times code must be retrieved from bulk storage during execution.

Input/output interface 506 couples the controller to I/O devices to be controlled (e.g., storage devices, etc.). Host system interface 508 may also couple the computer 500 to other data processing systems.

While the invention has been illustrated and described in the drawings and foregoing description, such illustration and description is to be considered as exemplary and not restrictive in character. One embodiment of the invention and minor variants thereof have been shown and described. In particular, features shown and described as exemplary software or firmware embodiments may be equivalently implemented as customized logic circuits and vice versa. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

What is claimed is:

1. A method operable in an I/O controller device for limiting performance of the I/O controller device, the method comprising:
determining, within the I/O controller device, a maximum performance threshold value for the I/O controller device;
determining, within the I/O controller device, performance of the I/O controller device during processing of I/O requests by the I/O controller device; and
delaying processing of an I/O request within the I/O controller device to maintain performance of the I/O controller device below the maximum performance threshold value.

2. The method of claim 1
wherein the step of determining performance of the I/O controller device further comprises:
periodically determining performance of the I/O controller device; and
averaging a plurality of performance determinations to determine an average performance over a predetermined period of time, and
wherein the step of delaying further comprises:
delaying processing of an I/O request to maintain the average performance below the desired maximum performance threshold value.

3. The method of claim 2
wherein the step of averaging further comprises:
averaging a predetermined number of the most recent of the plurality of performance determinations so that the average performance is determined by a moving average window.

4. The method of claim 2
wherein the step of averaging further comprises:
changing the predetermined period of time.

5. The method of claim 1
wherein the step of determining further comprises:
determining the maximum performance threshold value as one or more of: a maximum number of I/O requests to be processed in a period of time or a maximum volume of data to be processed by the I/O controller device over a period of time,
wherein the step of determining performance of the I/O controller device further comprises:
determining one or more of: the actual number of I/O requests processed by the I/O controller device over a period of time or the volume of data processed by the I/O controller device, and
wherein the step of delaying further comprises:
delaying processing of an I/O request if processing of the I/O request would cause the actual number of I/O requests processed by the I/O controller device over a period of time to exceed the maximum number of I/O requests to be processed by the I/O controller device in a period of time and/or if processing the I/O request would cause the volume of data processed by the I/O controller device over a period of time to exceed the maximum volume of data to be processed by the I/O controller device over a period of time.

6. The method of claim 1 wherein the I/O controller device includes a cache memory selectively used for processing of an I/O request,
wherein the step of determining further comprises:
determining the maximum performance threshold value as one or more of: a maximum number of I/O requests to be processed using the cache memory in a period of time or a maximum number of I/O requests to be processed without using the cache memory in a period of time,
wherein the step of determining the performance of the I/O controller device further comprises:
determining one or more of: the actual number of I/O requests processed by the I/O controller device using the cache memory over a period of time or the actual number of I/O requests processed by the I/O controller device without using the cache memory over a period of time, and
wherein the step of delaying further comprises:
delaying processing of an I/O request if processing of the I/O request would cause the actual number of I/O requests processed by the I/O controller device using the cache memory over a period of time to exceed the maximum number of I/O requests to be processed by the I/O controller device using the cache memory in a period of time and/or if processing of the I/O request would cause the actual number of I/O requests processed by the I/O controller device without using the cache memory over a period of time to exceed the maximum number of I/O requests to be processed by the I/O controller device without using the cache memory in a period of time.

7. The method of claim 1 further comprising:
maintaining multiple I/O queues in the I/O controller device where each queue stores I/O requests waiting to be processed and wherein each queue is associated with a corresponding connection to a corresponding system that generated the I/O requests stored in the corresponding queue,
wherein the step of delaying further comprises:
responsive to delaying processing of the I/O request, determining whether another I/O request stored in another queue may be processed without exceeding the desired maximum performance threshold; and
responsive to determining that said another I/O request may be processed, processing said another I/O request.

8. An I/O controller device adapted to provide a configurable level of performance, the controller device comprising:
an I/O request processing module adapted to receive I/O requests from one or more host systems and adapted to exchange information with one or more I/O devices to process the received I/O requests;
a memory for storing one or more maximum performance threshold values; and
a performance monitor and control module coupled with the I/O request processing module and coupled with the memory, the performance monitor and control module operable to monitor performance of the I/O request processing module and operable to control operation of the I/O request processing module responsive to the monitoring to assure that performance of the I/O request processing module does not exceed any of the one or more maximum performance threshold values.

9. The controller device of claim 8 wherein the performance monitor and control module is further operable to:
determine a period of time over which performance of the I/O request processing module is averaged;
determine the average performance of the I/O request processing module during the present period of time;
determining whether a received I/O request may be processed in the present period of time without the average performance of the I/O request processing module exceeding any of the one or more maximum performance threshold values; and
responsive to a determination that the received I/O request cannot be processed in the present period of time, delaying processing of the received I/O request by the I/O request processing module until expiration of the present period of time.

10. The controller device of claim 9
responsive to the expiration of the present period of time the performance monitor and control module is further operable to:
beginning a next period of time as a present period of time;
resetting the average performance of the I/O controller device; and
allowing processing by the I/O request processing module of any delayed I/O requests during the present period of time.

11. The controller device of claim 8 further comprising:
a memory for storing one or more queues each queue associated with a corresponding host system wherein each received I/O request is stored in a queue corresponding to the host system from which the I/O request was received,
wherein the performance monitor and control module is further operable to:
responsive to delaying processing of an I/O request stored in a first queue the performance monitor and control module is further operable to:
locate another I/O request stored in another queue that may be processed during the present period of time without the average performance of the storage controller exceeding any of the one or more maximum performance threshold values; and
process said another I/O request during the present period of time.

12. The controller device of claim 8
wherein the one or more maximum performance threshold values comprises one or more of:
a maximum number of I/O requests processed in a period of time;
a maximum volume of data transferred to or from the controller device in a period of time;
a maximum number of I/O requests processed using a cache memory of the controller device in a period of time; or
a maximum number of I/O requests processed without using a cache memory of the controller device in a period of time.

13. A computer readable medium tangibly embodying programmed instructions which, when executed by a computer of a storage controller, perform a method for limiting performance of the storage controller, the method comprising:
determining a period of time over which performance of the storage controller is averaged;
determining one or more maximum performance threshold values; and
processing I/O requests received from one or more attached host system wherein the step of processing further comprises:
determining the average performance of the storage controller during the present period of time;
determining whether a received I/O request may be processed in the present period of time without the average performance of the storage controller exceeding any of the one or more maximum performance threshold values; and
responsive to a determination that the received I/O request cannot be processed in the present period of time, delaying processing of the received I/O request until expiration of the present period of time.

14. The medium of claim 13 the method further comprising:
responsive to the expiration of the present period of time performing the additional steps of:
beginning a next period of time as a present period of time;
resetting the average performance of the storage controller; and
processing any delayed I/O requests during the present period of time.

15. The medium of claim 13 the method further comprising:
associating each of multiple queues with a corresponding attached host system wherein each received I/O request is stored in a queue corresponding to the attached host from which the I/O request was received,
wherein the step of processing further comprises:
responsive to delaying processing of an I/O request stored in a first queue performing the steps of:
locating another I/O request stored in another queue that may be processed during the present period of time without the average performance of the storage controller exceeding any of the one or more maximum performance threshold values; and
processing said another I/O request during the present period of time.

16. The method of claim 13
wherein the method step of determining one or more maximum performance threshold values further comprises:
determining one or more maximum performance threshold values as one or more of:
a maximum number of I/O requests processed in a period of time;
a maximum volume of data transferred to or from the storage controller in a period of time;
a maximum number of I/O requests processed using a cache memory of the storage controller in a period of time; or
a maximum number of I/O requests processed without using a cache memory of the storage controller in a period of time.
